(19) United States
(12) Patent Application Publication
(10) Pub. No.: US 2006/0149672 A1
(43) Pub. Date: Jul. 6, 2006

(54) Data processing system for managing and configuring an electronic transmission of a deposit

(76) Inventor: Robert Lane Minor, Lorena, TX (US)

Correspondence Address: R. LANE MINOR, 240 VISTA GRANDE LOOP, LORENA, TX, 76655, US

(21) Appl. No.: 11/028,439

(22) Filed: Dec. 31, 2004

(51) Int. Cl. G06Q 40/00

(52) U.S. Cl. 705/42

(57) ABSTRACT

A data processing system for managing and configuring an electronic transmission of a deposit with the steps of: computer processor for processing data, storage for storing data on a storage medium, transmit data for sending data, network for connecting computers and computer processors for sharing data, signaling check processing structure that a check is presented for processing, checkout register will transmit the amount due total to the check encoder, check processing structure including, a check encoder, payee printer, image recorder, encoding reader, when check is placed in check processing structure it will proceed through the structure, encoding the check with the amount due total, printing the payee, recording an image, and reading the encoding, recorded image and encoded reading will be transmitted to the storage medium, and stored encoded readings, readings total and images will be transmitted at a programmed chronological time for deposit.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of data processing and more specifically to a data processing system for managing and configuring an electronic transmission of a deposit. Businesses have always had the task of adding their checks and delivering them to be deposited. The more checks, the larger the task because typically financial institutions require deposits be made by a specific time in order to receive credit the same business day. A small percentage of businesses have implemented their own internal proof operation so they would be able to deposit more checks each day and reduce financial institution charges. Whatever method is used, the goal is the same; to deposit as many checks as possible and reduce cost. Businesses would take their deposit to their financial institution. The institutions teller would receive the deposit and then the proof operator would take the deposit and manually enter the amount each check was written for and the proof machine would encode the amount on the check. The prior process is deficient in that it limits the number of checks that are deposited each day, and the results of that is a smaller collected account balance, and that typically results in a higher monthly service charge. Also, financial institutions usually will charge a customer a monthly charge for each check that is deposited to their account. Another deficiency is that user's that are not running the operation internally are not able to configure the process to meet their individual needs whether they are going to manually deposit their checks or transmit them electronically.

### BRIEF SUMMARY OF THE INVENTION

The primary object of the invention is to provide user a more efficient way of processing their checks.

Another object of the invention is to provide user the ability to deposit more checks each day.

Another object of the invention is to provide user an increase in their collected balance.

A further object of the invention is to provide user with a reduction in financial institution charges.

Yet another object of the invention is to provide user with a reduction in operational cost.

Still yet another object of the invention is to provide user the ability to better manage increases in seasonal and monthly check volume.

Another object of the invention is to provide user a system to manage the check processing of multiple geographical locations from multiple geographical locations

Another object of the invention is to provide user a system to manage and configure their check processing.

A further object of the invention is to provide user a system to electronically transmit their deposit.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a data processing system for managing and configuring an electronic transmission of a deposit, comprising the steps of: computer processor a means for processing data, storage means for storing data on a storage medium, transmit data a means for sending data, network means for connecting computers and computer processors for sharing data, a means for signaling check processing structure a check is presented for processing, checkout register will transmit the amount due total to the check encoder, check processing structure comprised of; a check encoder, payee printer, image recorder, encoding reader, check is placed in check processing structure, check will proceed through the structure, encoding the check with the amount due total, printing the payee, recording an image, and reading the encoding, recorded image and encoded reading will be transmitted to the storage medium, and stored encoded readings, readings total, and recorded images will be transmitted at a programmed chronological time for deposit.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

### FIGURES

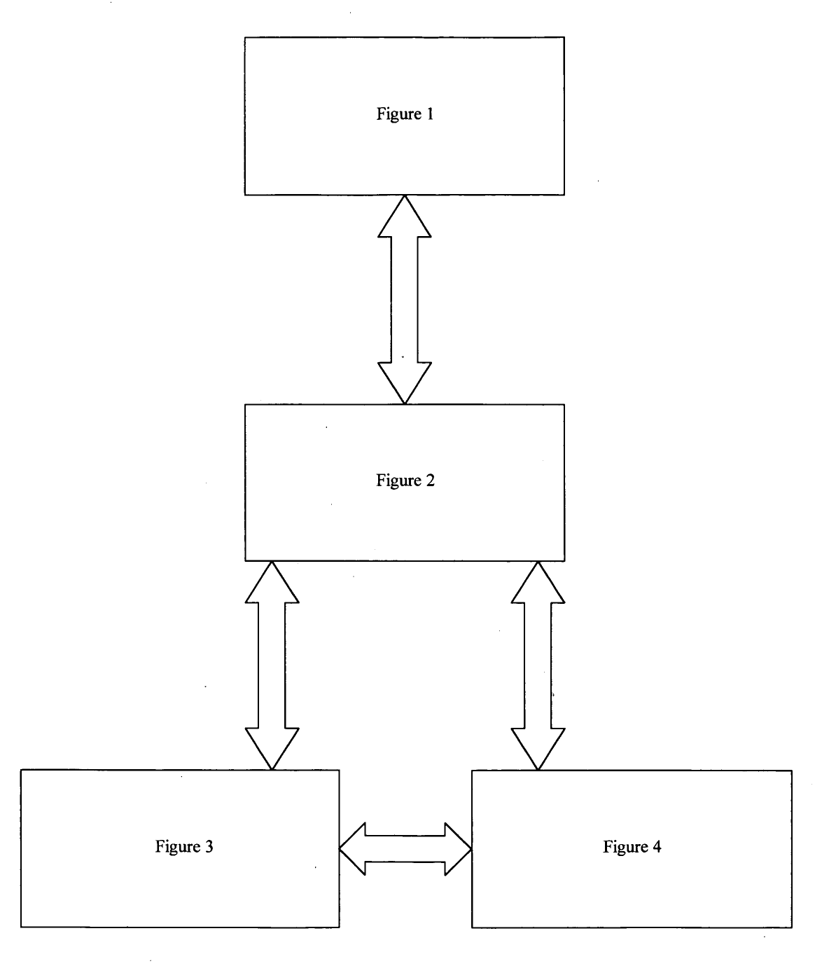

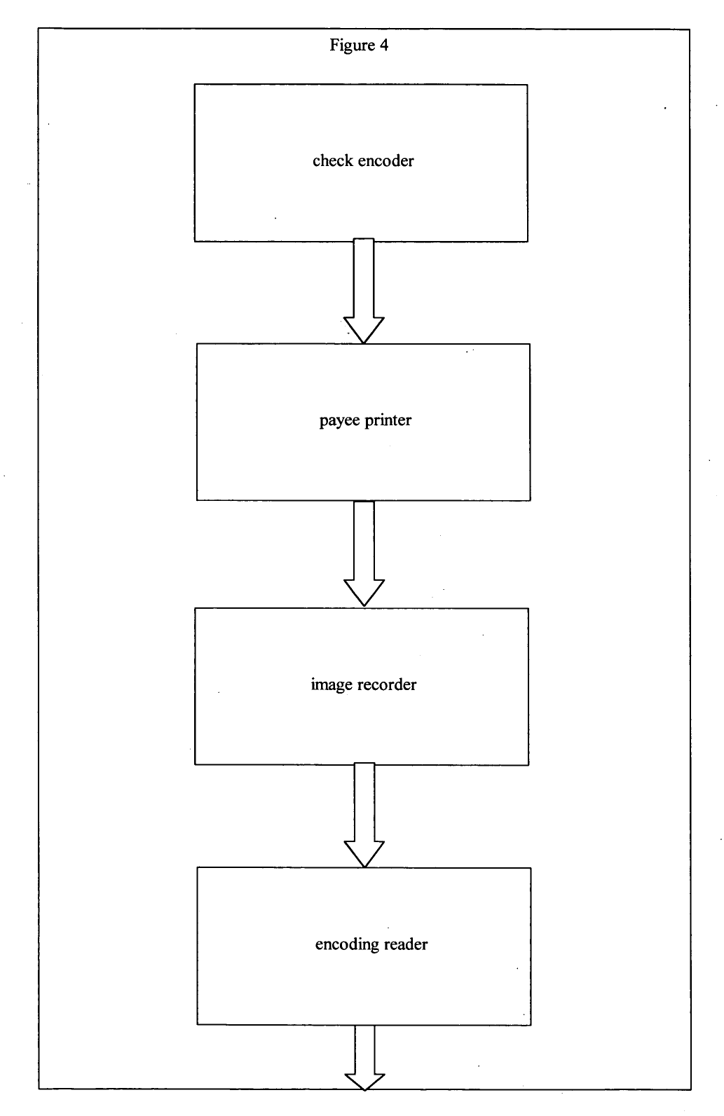

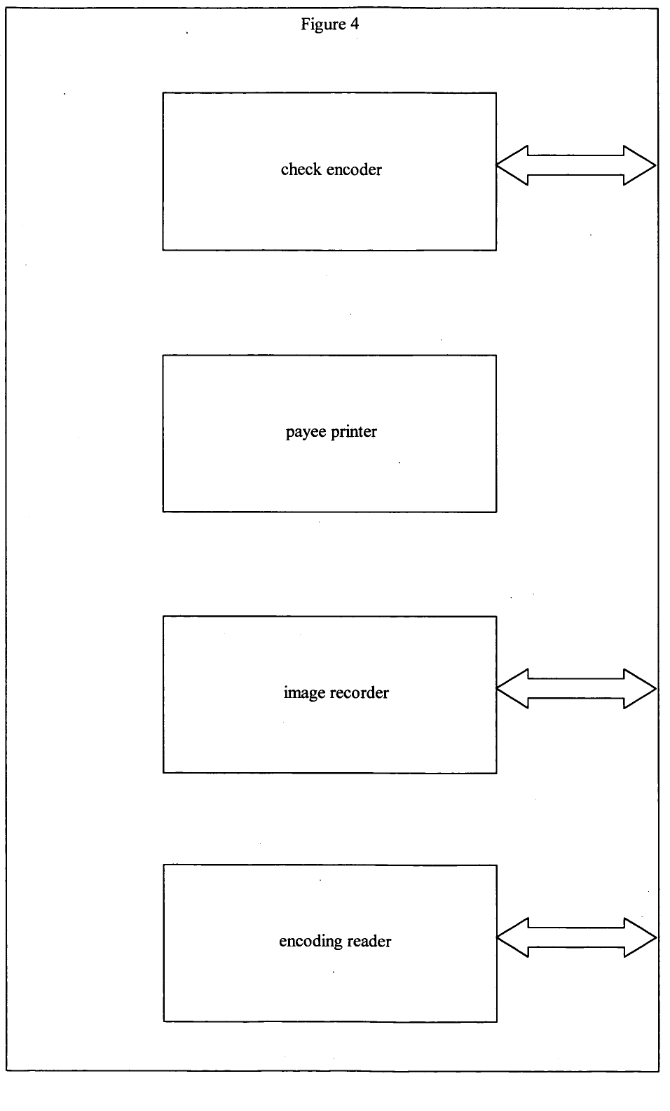

Page 1 shows FIG. 1 a large geographic area, FIG. 2 is the network, FIG. 3 is the checkout register, and FIG. 4 is the check processing structure. Page 1 also shows how the data is transmitted from each structure.

Page 2 shows FIG. 4 and how the checks will proceed through the structure.

Page 3 shows the direction that the data is transmitted. The checkout register transmits the amount due total to the check encoder. The recorded image is transmitted to the network and the encoded reading is transmitted to the network

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Turning first to the Figures: FIG. 1 is a large geographic area. FIG. 2 is a network, a means for connecting computers and computer processors for sharing data. FIG. 3 is a checkout register. FIG. 4 is the new feature of this invention, a check processing structure comprised of a check encoder, payee printer, image recorder, and encoding reader. The previous figures will also be comprised of; computer processor a means for processing data; storage means for storing data on a storage medium; transmit data means for sending data; network means for connecting computers and computer processors for sharing data; a means for signaling check processing structure a check is presented for processing. By way of illustration my invention will provide a data processing system for managing and configuring an electronic transmission of a deposit. Following the preferred procedure comprising the steps of FIG. 3 will transmit the amount due total to the check encoder, when the check is placed in FIG. 4 it will proceed through encoding with the amount due total, printing the payee, recording the image, and reading the encoding. The recorded image and the encoded reading will be transmitted to FIG. 2. Stored encoded readings, readings total, and recorded images will be transmitted at a programmed chronological time for deposit. One alternative to implementing my invention is to add a means for endorsing checks and this would allow a user to use the efficiency of this invention but instead of transmitting the deposit electronically they would make the deposit manually at their financial institution. It is so noted that my invention would be comprised of a means for processing data regarding encoded readings, encoded amount totals and recorded images; further comprising a means for calculating encoded amounts and encoded amount totals; further comprising a means for connecting to a large geographic area; further comprising a means for inputting and storing on the storage medium the chronological time the deposit is to be electronically transmitted; further comprising a means for retrieving from the storage medium data regarding daily, weekly, monthly, quarterly, and yearly encoded readings, encoded reading totals and recorded images; further comprising a means for checks to proceed to a specific location that the encoding reader is unable to read; further comprising a means for storing on the storage medium the value identifying the storage medium; further comprising a means for connecting multiple checkout registers and check processing structures to the network; further comprising a means for identifying each check and the date, time, and location it was processed; further comprising a means for viewing data; further comprising a means for manually entering encoding; further comprising a means for entering reading of encoding.

The advantages are great beginning with the increase in efficiency which will allow more time to process and deposit checks each day which will typically increase the user's collected balance. Now with the user's collected balance higher and their financial institution no longer processing their checks this should reflect in a drastic reduction associated with these fees and service charges. Another benefit of the invention is seasonal and monthly check volume increases will no longer be a burden since the user no longer has to prepare their checks and deliver them for deposit. Another benefit is a user with multiple geographic locations will now have the ability to view and manage from multiple geographic locations.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A data processing system for managing and configuring an electronic transmission of a deposit comprising the steps of:
computer processor a means for processing data;
storage means for storing data on a storage medium;
transmit data means for sending data;
network means for connecting computers and computer processors for sharing data;
a means for signaling check processing structure a check is presented for processing;
checkout register will transmit the amount due total to the check encoder;
check processing structure comprised of; a check encoder, payee printer, image recorder, encoding reader;
check is placed in check processing structure, check will proceed through the structure, encoding the check with the amount due total, printing the payee, recording an image, and reading the encoding;
recorded image and encoded reading will be transmitted to the storage medium;
stored encoded readings, readings total, and images will be transmitted at a programmed chronological time for deposit;

2. A data processing system for managing and configuring an electronic transmission of a deposit as claimed in claim 1 further comprising a means for processing data regarding encoded readings, readings amount total, and recorded images

3. A data processing system for managing and configuring an electronic transmission of a deposit as claimed in claim 2 further comprising a means for processing data regarding daily, weekly, monthly, quarterly, and yearly encoded readings and readings amount totals

4. A data processing system for managing and configuring an electronic transmission of a deposit as claimed in claim 3 further comprising a means for calculating encoded reading amounts and readings amount total

5. A data processing system for managing and configuring an electronic transmission of a deposit as claimed in claim 4 further comprising a means for connecting to a large geographic area

6. A data processing system for managing and configuring an electronic transmission of a deposit as claimed in claim 5 further comprising a means for viewing data

7. A data processing system for managing and configuring an electronic transmission of a deposit as claimed in claim 6 further comprising means for inputting and storing on the storage medium the chronological time the deposit is electronically transmitted

8. A data processing system for managing and configuring an electronic transmission of a deposit as claimed in claim 7 further comprising a means for retrieving from the storage medium data regarding daily, weekly, monthly, quarterly, and yearly encoded readings, readings amount total, and recorded images

9. A data processing system for managing and configuring an electronic transmission of a deposit as claimed in claim 8 further comprising a means for endorsing checks

10. A data processing system for managing and configuring an electronic transmission of a deposit as claimed in claim 9 further comprising a means for storing on the storage medium the value identifying the storage medium

11. A data processing system for managing and configuring an electronic transmission of a deposit as claimed in claim 10 further comprising a means for connecting multiple checkout registers and check processing structures to the network

12. A data processing system for managing and configuring an electronic transmission of a deposit as claimed in claim 11 further comprising a means for identifying each check and the date, time, and location it was processed

13. A data processing system for managing and configuring an electronic transmission of a deposit as claimed in claim 12 further comprising a means for checks that the encoding reader is unable to read to proceed to a specific location

14. A data processing system for managing and configuring an electronic transmission of a deposit as claimed in claim 13 further comprising a means for manually entering encoding

15. A data processing system for managing and configuring an electronic transmission of a deposit as claimed in claim 14 further comprising a means for manually entering reading of encoding
